(19) United States
(12) Patent Application Publication
(10) Pub. No.: US 2012/0303590 A1
(43) Pub. Date: Nov. 29, 2012

(54) MANAGEMENT OF DEDUPLICATED DATA DURING RESTORATION IN A NETWORK ARCHIVAL AND RETRIEVAL SYSTEM

(76) Inventor: Andrew Chernow, Jupiter, FL (US)

(21) Appl. No.: 13/117,068

(22) Filed: May 26, 2011

(51) Int. Cl. G06F 17/30

(52) U.S. Cl. 707/675; 707/E17.005

(57) ABSTRACT

A method, system, and computer program product for reduplicating data in a data storage system is provided. The method includes retrieving a restore set in response to receiving a request to restore deduplicated data, identifying the deduplicated data in the restore set, creating a list of unique data block identifiers for the deduplicated data, and restoring the deduplicated data into a target location by downloading only block data content from a storage node that corresponds to the unique list of data block identifiers.

### CROSS-REFERENCE TO RELATED APPLICATIONS

This application is related to U.S. patent application Ser. No. ______ filed on ______ entitled “Incremental Restore Identification in a Network Archival and Retrieval System” the teachings of which are hereby incorporated by reference.

### BACKGROUND OF THE INVENTION

1. Field of the Invention

The present invention relates to data archival and retrieval and more particularly to data de-duplication during data archival and retrieval in a network data storage system.

2. Description of the Related Art

A computer file is composed of multiple blocks of information. The process of putting data into blocks is called blocking. Blocking facilitates the handling of the data-stream by the computer program receiving the data. At any instant in time each block has a size, normally expressed as number of bytes that indicates how much storage is required to store the file. The blocks of data that form a computer file are stored on a data storage device—such as a hard disk, magnetic tape, or a compact disc—and can be local to the computer creating the file, directly attached to the computer creating the file, or attached to a distant device.

When computer files contain information that is important, a back-up process is used to protect against disasters that might destroy the files. Backing up files simply means making copies of the files (the blocks that composed the files) in separate locations so that they can be restored if something happens to the computer or if they are deleted accidentally. Most computer systems provide server-based utility programs to assist in the back-up process, but server-based programs can tie up network resources (reducing a network's speed) if there are many files to safeguard or many computers on a network. In addition, many systems, especially networked systems, have multiple copies of the same files; storing multiple copies of redundant data can be expensive as it requires additional storage space and requires network resources to transport the file blocks to the storage devices, thereby limiting the availability of network resources for other jobs.

Data deduplication is a data compression technique for eliminating redundant data. In the deduplication process, duplicate data is deleted, leaving only one copy of the data to be stored along with references to the unique copy of the data. Depending on the type of deduplication, redundant files, or even portions of other data that is similar, can be reduced or removed. For example, in file based duplication, an email system may have one-hundred instances of the same attachment. With data duplication, only one instance of the attachment is actually stored; each subsequent instance is just referenced back to the one saved copy. Typically, data deduplication occurs at a storage target, commonly at a network-attached storage (NAS) device, resulting in a centralized deduplication process rather than a distributed one. During restoration, the single instance of a file can be restored multiple times to multiple different locations resulting in substantially quicker restoration times.

### BRIEF SUMMARY OF THE INVENTION

Embodiments of the present invention address deficiencies of the art in respect to restoring deduplicated data and provide a novel and non-obvious method, system and computer program product for restoring deduplicated data in a network archival and retrieval system. In an embodiment of the invention, a method for restoring deduplicated data is provided and includes retrieving a restore set from a database in response to receiving a request to restore deduplicated data re-downloaded and identifying the deduplicated data in the restore set. The method can further include creating a unique list for the deduplicated data and restoring the deduplicated data into a target location by downloading only block data content (or data block content) from a storage node that corresponds to the unique list of data block identifiers.

Another embodiment of the invention provides for a data reduplication system for restoring deduplicated data in a data archival and retrieval system. The data reduplication system can include a computer configured to support a database, an agent application, and a deduplicated data restoring module executing on the computer as part of the agent application. The deduplicated data restoring module can include program code for retrieving a restore set from a database in response to receiving a request to restore deduplicated data, identifying the deduplicated data in the restore set, creating a unique list of data block identifiers for the deduplicated data, and restoring the deduplicated data into a target location by downloading only the block data content from a storage node that corresponds to the unique list of data block identifiers.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for restoring deduplicated data in a network archival and retrieval system;

FIG. 2 is a schematic illustration of a data reduplication system; and,

FIG. 3 is a flow chart illustrating a process for rehydrating deduplicated data.

### DETAILED DESCRIPTION OF THE INVENTION

Embodiments of the invention provide for reduplication of deduplicated data in a data storage system. In accordance with an embodiment of the invention, a client-side agent application receives a request from a database of metadata also referred to as a metadata store to restore deduplicated data stored in a data storage system. In response to receiving the request, a restore set can be fetched. The restore set can include metadata describing the files requested to be restored. Thereafter, deduplicated data in the restore set can be identified, so that a list of unique data block identifiers (block IDs) that excludes redundant block identifiers can be determined. The data in the blocks associated with the list of unique block IDs then can be retrieved by the client-side computer containing the agent application. In this way, the data retrieved by the client-side computer represents only unique data blocks that must be retrieved through the network in order to complete restoration of the deduplicated data, thereby reducing network usage and distributing the rehydration process as opposed to rehydrating locally by way of a NAS or other deduplication storage appliance, which requires the reconstituted form to be sent through the network using more network resources than necessary.

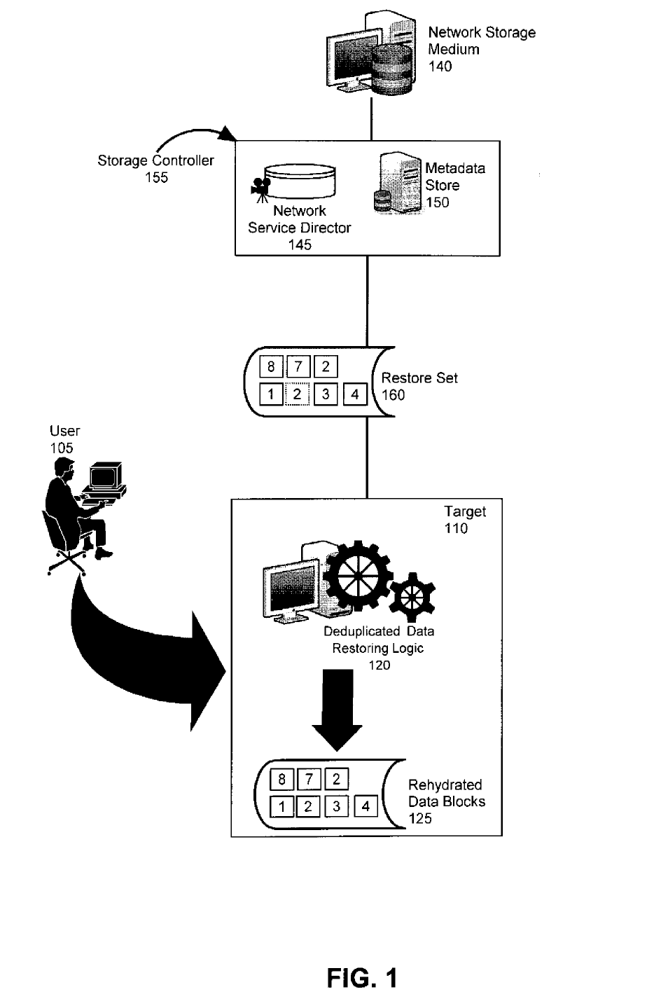

In further illustration, FIG. 1 pictorially shows a process for restoring (or rehydrating or reduplicating) deduplicated data in a network archival and retrieval system. As shown in FIG. 1, a user 105 from the user's computing device requests that an item (a file, an object, etc.) that has been backed-up and stored be restored (recovered). In one embodiment, the user 105 uses a web (Internet) application from the user's computing device to select which items are to be restored. Optionally, the user 105 may select where the restored item(s) is/are to be placed; in other words, the user 105 can select where the restored item is to be restored to. A user's 105 specific computing device is not limited, but can include a laptop computer, a smart phone, a tablet, and a personal digital assistant (PDA).

Upon receiving the user's request to restore a specific item, a metadata store 150 sends a restore job request to a client-side agent application on a target 110. The target 110 or target system is where (on which computing device) the item to be restored will be placed. The metadata store (MDS) 150 is a database that contains information about each block, which is usually organized in tables. The block information contained in the MDS 150 is not limited to specific information but can include: the block's ID, where the block's content is stored (i.e. on what storage device); revision information; the file a block is associated with; and block size.

The storage controller 155, which is also called the sphere controller, is the name given to the combination of the network service director (NSD) 145 and the MDS 150. The storage controller 155 via the NSD 145 and the MDS 150 manages revision control, deduplication lookup engine, backups and restores, job scheduling, retention policies and enforcement, snapshot policies and enforcement, agent sessions, users and block locations, among other things. The NSD 145 and the MDS 150 can be located on the same computing device or on different devices. The NSD 145 is responsible for such things as telling the client application which network storage medium 140 to work with during block restoration as well as informing the network storage medium 140 what other network storage medium to go to in order to retrieve additional blocks during the restoration (recovery) process. A network storage medium 140 can include any type of storage device, including a universal storage node, a volume disk, and magnetic tape. The network storage medium 140 is where the block data content is stored.

After receiving the restore job request from the MDS 150, the client-side deduplicated data restoring logic 120 on the target 110 fetches a restore set 160 from the MDS 150. The restore set 160 can include information (metadata) about the files (items) requested to be restored. The information included in the restore set 160 is not limited to, but may include a file's name, the block identifiers associated with the file, the block's offset, the block's size, the block's mtime (time of last modification), and the block's ctime (time of last status change). The restore set 160 contains block identifiers, which includes block IDs of deduplicated data blocks. The deduplicated data restoring logic 120 identifies the redundant block identifiers and creates a list of unique data block identifiers that excludes any redundant block identifiers. As an example, if a restore set 160 includes block IDs for the object entitled “File1” as [7 10 15] and for the object entitled “File2” as [7 15 9], then the unique set of data block identifiers is [7, 10, 15, and 9] as it excludes the redundant block identifiers.

After the deduplicated data restoring logic 120 creates the list of data block identifiers, the logic 120 downloads (reduplicates or restores) the deduplicated data blocks to re-form the rehydrated data blocks 125. In addition, the deduplicated data restoring logic 120 determines where to retrieve the previously downloaded block data content. Whether blocks already downloaded are re-downloaded is determined by the deduplicated data restoring logic 120 based on whether it is more efficient—according to several factors including available system resources and network speed—to re-download the data content associated with a specific block identifier. In other words, the deduplicated data restoring logic 120 makes a determination whether to source (retrieve) the already restored data set from the target 110 or from somewhere else, such as a universal storage appliance or a server.

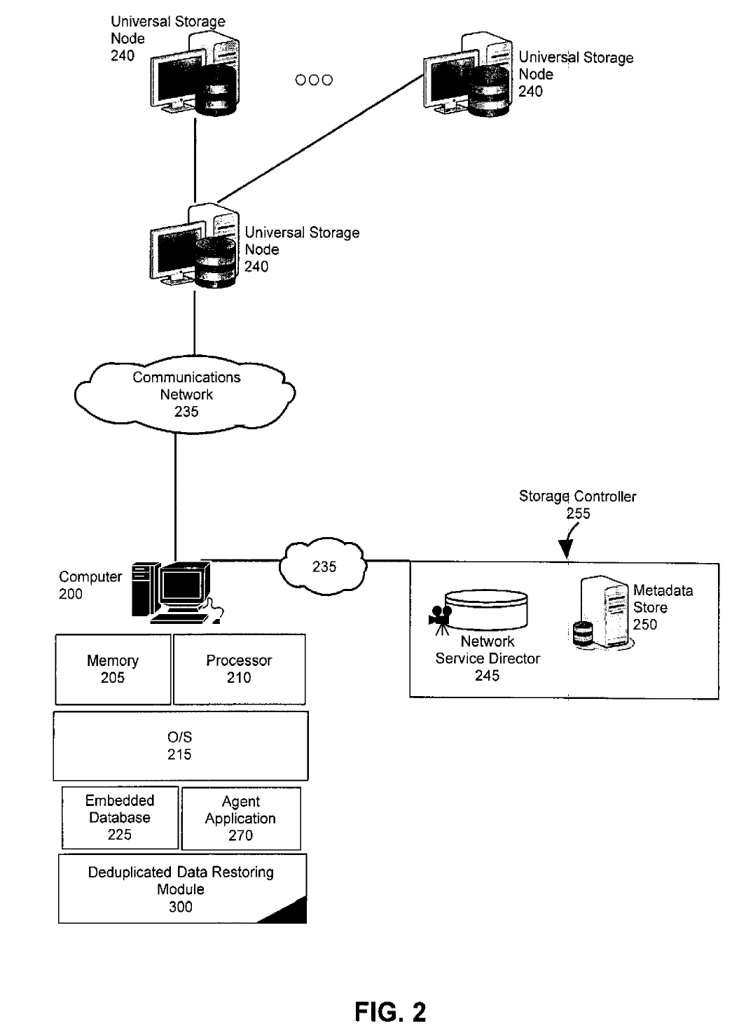

The process described in connection with FIG. 1 can be implemented in a system as shown in FIG. 2. In further illustration, FIG. 2 schematically shows a data reduplication system. A data reduplication system can include a computer 200. The computer 200 can include at least one processor 210 and memory 205 supporting the execution of an operating system (O/S) 215. The O/S 215 in turn can support an embedded database 225 and an agent application 270.

The embedded database 225 is a database that contains information about which blocks have been restored and where the restored data blocks were placed. Of further note, the embedded database 225 may include information pertaining to a block's path, a block's ID, a block's offset, and a block's size. The agent application 270 can support the deduplicated data restoring module 300, which can execute in memory 205 of the computer 200. The agent application 270 is a client-side application that interacts with the system's components, including the MDS 250 and the universal storage nodes 240 of a data archival and retrieval system in order to perform a variety of job requests, such as reduplication and restoration (recovery).

The deduplicated data restoring module 300 communicates via a communications network 235 with a universal storage node (USN) 240, which can in turn communicate with other USNs 240 over a communications network (not pictured). The communications network 235 is not limited to the Internet, but can include wireless communications, Ethernet, 3G, and 4G. A universal storage node 240 is a type of network storage device (or network storage appliance) enabled to store data irrespective of a type or format of the data to be stored. Of note, though a USN is illustrated and referred to, any network storage appliance can be used in lieu of a USN. A USN 240 is where the data block content (block data content) is stored. The USN 240 is also where deduplicated blocks are marked for deletion. The deduplicated data restoring module 300 can also communicate via a communications network 235 with a storage controller 255. As indicated above, the storage controller 255 is the combination of a metadata store 250 and the network service director 245.

The deduplicated data restoring module 300 can include program code which, when executed by at least one processor 210 of the computer 200, retrieves a restore set from the MDS 250 in response to receiving a restore job request from the MDS 250 of a data storage system. The deduplicated data restoring module 300 can further include program code to identify deduplicated data in the restore set and to create a unique list of data block identifiers after identifying the deduplicated data in the restore set. Optionally, when creating the list of data block identifiers, the module 300 can further include program code to exclude a data block identifier upon determining that a data block identifier has already been included in the unique list of data block identifiers and to determine whether the data block identifier of data block content having previously been downloaded should be included in the unique list of data block identifiers for re-download. Upon creating a list of data block identifiers, the module 300 can include program code to download (to rehydrate) the block data content for each data block ID that was listed. Optionally, the deduplicated data restoring module 300 can further include program code to determine whether to re-download previous downloaded block data content from a target or from a server based on different factors, including system resources and network speed. In other words, the deduplicated data restoring module 300 can determine where to retrieve previously downloaded block data content—from the target or from a somewhere else, such as a USN or a server.

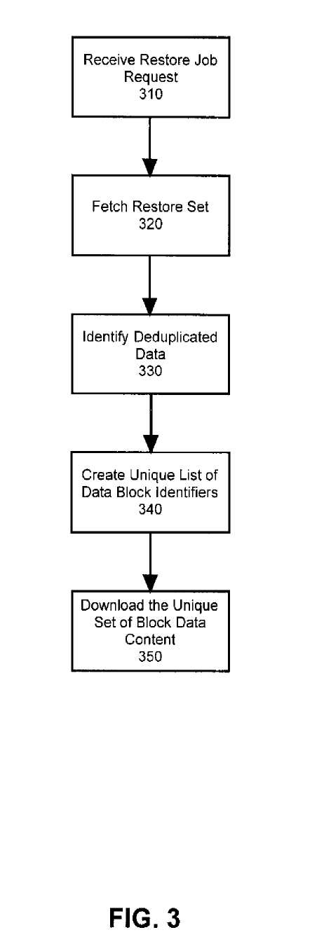

In even yet further illustration of the operation of the program code of the deduplicated data restoring module 300, FIG. 3 is a flow chart illustrating a process for restoring deduplicated data in a network archival and retrieval system. Beginning in step 310, a restore job request is received from the MDS. In step 320, a restore set is fetched. The restore set is retrieved from the MDS. The restore set can include as an example, an array of structures containing data pertaining to the items to be restored. The data or information contained in the structure is not limited, but can include revision metadata. Optionally, the metadata can include the name of a corresponding file and the block IDs for all the blocks that compose the file. The block IDs point to data stored in a block table, which can point to additional tables containing additional information about the block, including where copies are stored, information about the content in the block, and block size as well as other block and/or system information.

In step 330, blocks containing deduplicated data are identified. Upon determining which blocks contain deduplicated data, a unique list of data block identifiers is created as indicated in step 340. As another option, the unique list of data block IDs can include only those block IDs of blocks whose data content has not already been downloaded (retrieved). As yet another option, a block that has already been downloaded, may be re-retrieved, and thus, included in the unique set of data block IDs if it is determined to be faster and/or use less network resource consumptive than retrieving the already downloaded block. The unique list of data block IDs also includes the block IDs of those blocks which are not already included in the unique list; in other words, if a block has already been indicated as unique, a second instance of the same block ID would not be included in the unique list of data block IDs. Of note, in an aspect of the embodiment, a block inventory—namely a table in an embedded database—can be provided to store block information about which blocks have been restored and where the restored data blocks have been placed. Optionally, the embedded database also can store information pertaining to a block's path, a block's ID, a block's offset, and a block's size.

As an example, if a restore set includes block IDs for the object entitled “File1” as [7 10 15] and for the object entitled “File2” as [7 15 9] and the block inventory informs the agent application that block 10 was already downloaded (in other words, the data content for block 10 was already rehydrated), then the unique set of data block IDs is [7, 15, and 9]. As another example, if it is later determined that it would be desirable based upon system resources and other factors, such as block size and network speed, to download (retrieve) block 10 again, then it the unique set of data block IDs is [7, 10, 15, and 9].

Referring again to FIG. 3, the block data content is downloaded or rehydrated as indicated in step 350, after the unique list of data block IDs is created, thus reduplicating (or restoring) the data content into its original form. Optionally, the deduplicated data restoring logic may determine where to download (source) the already restored data block content, from the target system or from somewhere else, such as a server or USN, depending on system resources as part of the downloading of block data content. This can be in place of determining whether a unique block identifier of a block already downloaded should be re-downloaded, and thus included on the list of block identifiers to be rehyrdated. In other words, the deduplicated data restoring logic may determine where to retrieve previously downloaded block data content—the target or from somewhere else. Optionally, the restored deduplicated data can then be stored in a block cache. The reduplicated data can then be transported from the block cache to the requesting location into which the data is to be restored.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object-oriented programming language and conventional procedural programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

I claim:

1. A method for restoring deduplicated data comprising:
retrieving a restore set from a database in response to receiving a request to restore deduplicated data;
identifying deduplicated data in the restore set;
creating a unique list of data block identifiers for the deduplicated data; and,
restoring the deduplicated data into a target location by downloading only block data content from a storage node that corresponds to the unique list of data block identifiers.

2. The method of claim 1, wherein creating a unique list of data block identifiers for the deduplicated data comprises:
excluding data block identifiers from the unique list in response to determining that correspondingly identical data block identifiers already have been included in the unique list of data block identifiers

3. The method of claim 2, further comprising including data block identifiers in the unique list even though it is determined that that correspondingly identical data block identifiers already have been included in the unique list of data block identifiers when the data block identifiers to be included refer to data block content that although previously downloaded are to be re-downloaded.

4. A data reduplication system comprising:
a computer with at least one processor and memory;
a first database coupled to the computer;
an agent application executing on the computer; and,
a deduplicated data restoring module coupled to the agent application, the module comprising program code enabled to retrieve a restore set from a second database in response to receiving a request to restore deduplicated data, to identify deduplicated data in the restore set, to create a unique list of data block identifiers for the deduplicated data, and to restore the deduplicated data into a target location by downloading only block data content from a storage node that corresponds to the unique list of data block identifiers.

5. The system of claim 4, wherein the deduplicated data restoring module comprising program code enabled to create a unique list of data block identifiers for the deduplicated data comprises program code enabled to exclude data block identifiers from the unique list in response to determining that correspondingly identical data block identifiers already have been included in the unique list of data block identifiers.

6. The system of claim 5, wherein the deduplicated data restoring module comprising program code further comprises program code enabled to include data block identifies in the unique list even though it is determined that the correspondingly identical data block identifiers already have been included in the unique list of data block identifiers when the data block identifiers to be included refer to data block content that although previously downloaded are to be re-downloaded.

7. A computer program product for restoring deduplicated data, the computer program product comprising:
a computer readable storage medium having computer readable program code embodied therewith, the computer readable program code comprising:
computer readable program code for retrieving a restore set from a database in response to receiving a request to restore deduplicated data;
computer readable program code for identifying deduplicated data in the restore set;
computer readable program code for creating a unique list of data block identifiers for the deduplicated data; and,
computer readable program code for restoring the deduplicated data into a target location by downloading only block data content from a storage note that corresponds to the unique list of data block identifiers.

8. The computer program product of claim 7, wherein the computer readable program code for creating a unique list of data block identifiers for the deduplicated data comprises:
computer readable code for excluding data block identifiers from the unique list in response to determining that correspondingly identical data block identifiers already have been included in the unique list of data block identifiers.

9. The computer program product of claim 8, wherein the computer readable program code further comprises:
computer readable code for including data block identifiers in the unique list even though it is determined that correspondingly identical data block identifiers already have been included in the unique list of data block identifiers when the data block identifiers to be included refer to data block content that although previously downloaded are to be re-downloaded.
